(19) United States
(12) Patent Application Publication
(10) Pub. No.: US 2013/0207282 A1
(43) Pub. Date: Aug. 15, 2013

(54) AERATION APPARATUS

(71) Applicants: Rong-Feng Tsai, Huwei Township (TW); Wen-Yuh Jywe, Huwei Township (TW)

(72) Inventors: Rong-Feng Tsai, Huwei Township (TW); Wen-Yuh Jywe, Huwei Township (TW)

(21) Appl. No.: 13/397,366

(22) Filed: Feb. 15, 2012

(51) Int. Cl. B01F 3/04

(52) U.S. Cl. 261/5; 261/120; 261/34.1; 261/30

(57) ABSTRACT

An aeration apparatus is provided. The aeration apparatus includes a raft, a cruising device, and an aeration device. The aeration device is installed on the raft. In use, the raft floats on a water surface, the cruising device propels the raft back and forth on the water surface, and the aeration device diffuses bubbles under the water surface.

### BACKGROUND

1. Technical Field

The present disclosure relates to an aeration apparatus.

2. Description of Related Art

In fish farms or fishponds, aeration apparatuses are usually utilized to maintain the concentration of dissolved oxygen (DO) in water for enabling respiration of cultured creatures, aquatic creatures, and microorganisms. Aeration apparatuses are necessary for ensuring water quality and maintaining an ecological balance in fishponds. Microorganisms (or decomposers) have to absorb dissolved oxygen from water so as to decompose redundant organic material and perform nitrification, which transforms ammonia (NH₃) of higher toxicity into nitrous acid (NO₂) or nitric acid (NO₃) of lower toxicity. For example, paddle wheels may be utilized to splash water into the air for increasing the contact time and contact surface area between water and air, thereby achieving the purposes of aeration and increasing dissolved oxygen in the water.

However, the aerating capability of traditional paddle wheels utilized for fish farms is limited to water regions near the paddle wheels. For a larger fish farm, a number of paddle wheels have to be used so as to increase the DO concentration of pond water. Such an arrangement does not only consume much electric power, but also increases equipment costs due to a large number of paddle wheels.

Aerobic treatment ponds of wastewater treatment plants for environmental and chemical industries also use microorganisms to decompose organic matters. In these industries, blowers and air pipes are typically used to transport air to air-holes of bubble diffusers located adjacent to the bottom of a pond. Small bubbles are discharged near the bottom of the pond to increase the concentration of dissolved oxygen and to enhance dissipation of redundant organic material of water. However, the larger volume of water, the longer pipes and more apparatuses are needed to maintain the DO concentration of the pond water. Obviously, such an arrangement does not only increase costs of the equipment but also power consumption due to large pressure head losses.

Consequently, there is a need to develop an apparatus to save costs, save power, increase aeration efficiency, and increase the DO concentration close to the bottom of a pond.

### SUMMARY

An aspect of the present invention is to provide an aeration apparatus.

In an embodiment of the present invention, an aeration apparatus includes a raft, a cruising device, and an aeration device installed on the raft. In use, the raft floats on a water surface, the cruising device propels the raft back and forth on the water surface, and the aeration device diffuses bubbles close to the pool bottom.

In the aforementioned embodiment of the present invention, the cruising device propels the raft and the aeration device, so that the aeration apparatus expands an aerating region effectively without the need to increase the length of pipes and number of aeration devices.

### BRIEF DESCRIPTION OF THE DRAWINGS

FIG. 1 is a side view of an aeration apparatus of a first embodiment of the present invention;

FIG. 2 is a top view of the aeration apparatus shown in FIG. 1;

FIG. 3 is a top view of an aeration apparatus of a second embodiment of the present invention;

FIG. 4 is a top view of an aeration apparatus of a third embodiment of the present invention;

FIG. 5 is a side view of an aeration apparatus of a fourth embodiment of the present invention; and

FIG. 6 is a side view of an aeration apparatus of a fifth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

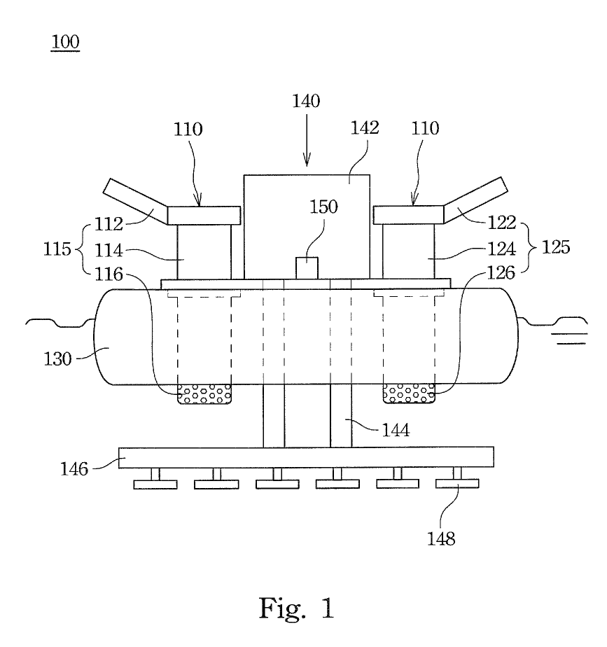

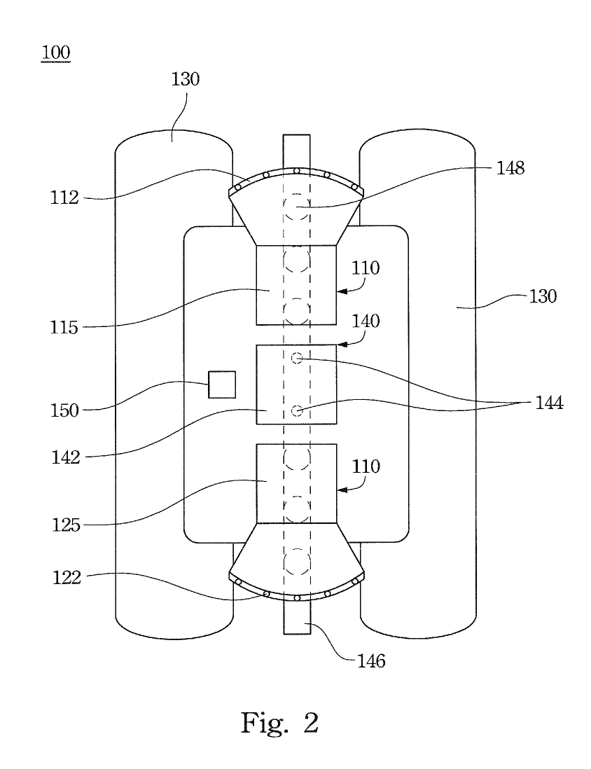

FIG. 1 is a side view of an aeration apparatus 100 of a first embodiment of the present invention. FIG. 2 is a top view of the aeration apparatus 100 shown in FIG. 1. The aeration apparatus 100 includes a cruising device 110, an aeration device 140, and a raft 130. The cruising device 110 and the aeration device 140 are installed on the raft 130, which can float on a water surface.

The aeration device 140 includes a blower 142 placed on the raft 130 for pumping air and exhausting air with pressure. An air outlet of the blower 142 is connected to an air pipe 144 extending to a manifold 146. The manifold 146 is subsequently connected to an air diffuser 148 for discharging a large number of small bubbles in a lower water layer which is above the pond bottom by 10 cm to 40 cm. The operation of the aeration device 140, purposely increases the concentration of dissolved oxygen (DO) in the lower water layer. The aeration device 140 may comprise a plurality of the air pipes 144, a plurality of the manifolds 146, and a plurality of the air diffusers 148. In addition, regardless of whether the cruising device 110 is operating or not, the aeration device 140 can operate independently to discharge a large number of small bubbles close to the bottom of the pond to increase the DO concentration of the lower water layer. The details of aeration device 140 will not be repeated in the following sections unless necessary.

The cruising device 110 includes a pair of pumping devices (i.e., a first pumping device 115 and a second pumping device 125), and a controller 150. The first pumping device 115 and the second pumping device 125 are mounted on the raft 130 for pumping and discharging water to generate thrust to propel the raft 130. The controller 150 is electrically connected to the first pumping device 115 and the second pumping device 125, and alternately switches on and off the first pumping device 115 or the second pumping device 125 to control the direction of thrust of water flow.

The first pumping device 115 includes a first pump 114, a first filter 116, and a first nozzle 112. The first nozzle 112 is mounted on the water outlet of the first pump 114, and is disposed above the raft 130. The first nozzle 112 extends outward obliquely at an angle from 15° to 50°. The first pumping device 115 may include a plurality of the first nozzles 112 disposed in a radial arrangement. The first filter 116 is attached to a water inlet of the first pump 114 for preventing the first pump 114 from sucking in external objects which may damage the first pump 114 and block the first nozzle 112.

The second pumping device 125 includes a second pump 124, a second filter 126, and a second nozzle 122. The second nozzle 122 is mounted on the water outlet of the second pump 124, and is disposed above the raft 130. The second nozzle 122 extends outward obliquely at an angle from 15° to 50°. The second pumping device 125 may include a plurality of the second nozzles 122 disposed in a radial arrangement. The second filter 126 is attached to a water inlet of the second pump 124 for preventing the second pump 124 from sucking in external objects which may damage the second pump 124 and block the second nozzle 122.

The first pump 114 and the second pump 124 may be water pumps or jet aerators. The filters attached on the water inlets of the pumps 114, 124 will not be described repeatedly in the description to follow.

The first nozzle 112 and the second nozzle 122 are located on opposite ends of the aeration apparatus 100, and discharge water outward in opposite directions, respectively. For example, when the first pump 114 is switched on and the second pump 124 is switched off, the first pump 114 pumps and discharges water through the first nozzle 112 to generate thrust. Such thrust propels the aeration apparatus 100 in a first direction of the pond. Similarly, when the second pump 194 is switched on and the first pump 114 is switched off, the second pump 124 pumps and discharges water through the second nozzle 122 to generate thrust. Such thrust propels the aeration apparatus 100 in a second direction of the pond.

As a result, the alternate operation of the first pumping device 115 and the second pumping device 125 propels the aeration apparatus 100 back and forth in the first and second directions of the pond, respectively, due to the corresponding change of thrust.

It is to be noted that the control of the propelling direction of the aeration apparatus 100 may be achieved by regulating the corresponding thrust levels of the first pumping device 115 and the second pumping device 125 of the cruising device 110. The thrust of the first and second pumping devices 115 and 125 increase with the horsepower of the pump, and the diameters of the flow channels of the nozzle, but decrease with the elevation angles of the flow channels of the nozzle.

For instance, the first pumping device 115 is arranged to generate small thrust due to the use of a first pump 114 of small horsepower, or a first nozzle 112 with flow channels of small diameters or large elevation angles.

In contrast, the second pumping device 125 is arranged to generate large thrust due to the use of a second pump 124 of large horsepower, or a second nozzle 122 with flow channels of large diameters or small elevation angles.

In this case, the first pumping device 115 of small thrust is always switched on, and the second pumping device 125 of large thrust is controlled by the controller 150. When the second pumping device 125 of large thrust is switched off by the controller 150, and the first pumping device 115 operates, the corresponding thrust generated from the first pump 114 propels the aeration apparatus 100 toward to the first direction.

After a period of time, the second pumping device 125 and the first pumping device 115 are both switched on by the controller 150. The aeration apparatus 100 is, therefore, propelled in the direction opposite to the first direction (i.e., the second direction) due to the larger thrust of the second pump 124.

As a result, the aeration apparatus 100 can increase the DO concentration of the whole regions where it is propelled back and forth by alternative switches on or off the second pumping device 125 associated with larger thrust via the controller 150.

In addition, the aeration apparatus 100 may further include a manual controller (not shown) electrically connected to the first pump 114 with the first nozzle 112 (the first pumping device 115), and the second pump 124 with the second nozzle 122 (the second pumping device 125).

The manual controller controls which of the first pump 114 and the second pump 124 generates thrust when pumping and discharging water flow through the first nozzle 112 and the second nozzle 122, respectively. The aeration apparatus 100 is, therefore, propelled in the direction of the resultant thrust.

It is to be noted that manual power generation devices may also be used as power inputs of the first pump 114 and the second pump 124, and the controller 150. The first pumping device 115 and the second pumping device 125 discharge water and generate thrust according to the corresponding manual power generation devices. Consequently, the aeration apparatus 100 is propelled in the direction of the resultant thrust due to the two pumping devices 115 and 125.

In the above embodiments, a rope may be used to guide the desired propelling direction and distance of the aeration apparatus 100, and limit its movement within design deviations to against external forces, due to wind, wave water currents and etc.

It is to be noted that the locations and numbers of the pump of the cruising device 100 mentioned above may help the aeration apparatus to move in different directions. Moreover, the geometric shapes, numbers, and arrangements of the air pipe, the manifold, and the air diffuser may be changed as needed. Much of the information described in the above embodiments will not be repeated in the following description, and only embodiments related to the cruising device will be described.

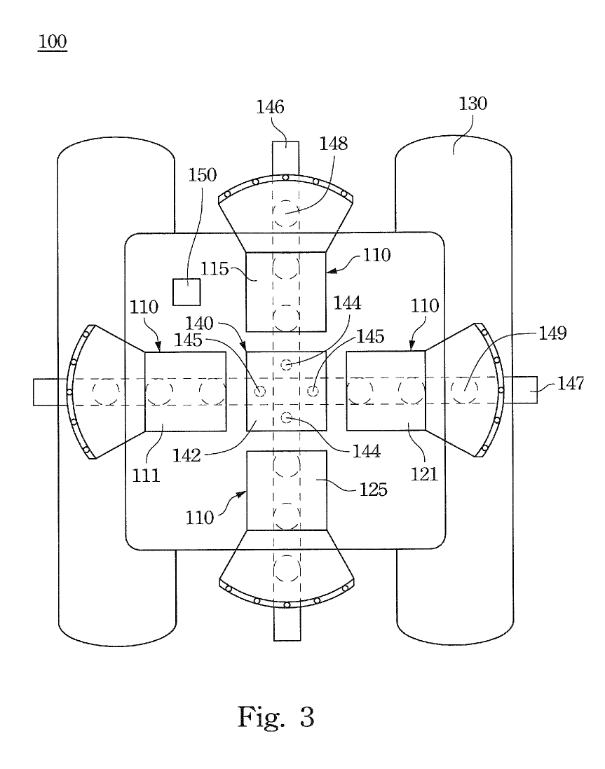

FIG. 3 is a top view of an aeration apparatus 100 of a second embodiment of the present invention. The aeration apparatus 100 includes the cruising device 110, the aeration device 140, and the raft 130. The cruising device 110 includes two pairs of the pumping devices (i.e., the first pumping device 115, the second pumping device 125, a third pumping device 111, and a fourth pumping device 121), and the controller 150. The first pumping device 115, the second pumping device 125, the third pumping device 111, and the fourth pumping device 121 are mounted on four sides of the raft 130, respectively, in a ring-shaped arrangement. The controller 150 may control each of the first pumping device 115, the second pumping device 125, the third pumping device 111, and the fourth pumping device 121 to switch on and off. In this embodiment, some of the pumping devices switched on may pump and discharge water through their corresponding nozzles for aerating and generating thrust, so that the aeration apparatus 100 is propelled in a direction opposite to the direction of the resultant thrust. For example, switching on three pumping devices and switching off the other one, or switching on two adjacent pumping devices and switching off the other two propels the aeration apparatus 100 in a direction opposite to the direction of the resultant thrust in the pond.

In this embodiment, the controller 150 may switch on one, two, or three pumping devices of the aeration apparatus 100, and may switch off the other pumping device(s). As a result, the aeration efficiency of the aeration apparatus 100 is increased since it can be propelled in four different directions of the pond expands.

Furthermore, ropes may be used to guide the movement and direction of the aeration apparatus 100 within a designed direction or range. Therefore, the purpose of propelling the aeration apparatus 100 back and forth can be carried out in a more precise manner with less deviation off the designed route due to wind, water currents, or other external forces.

It is to be noted that the elements shown in FIG. 3 may be the same as the elements shown in FIG. 1.

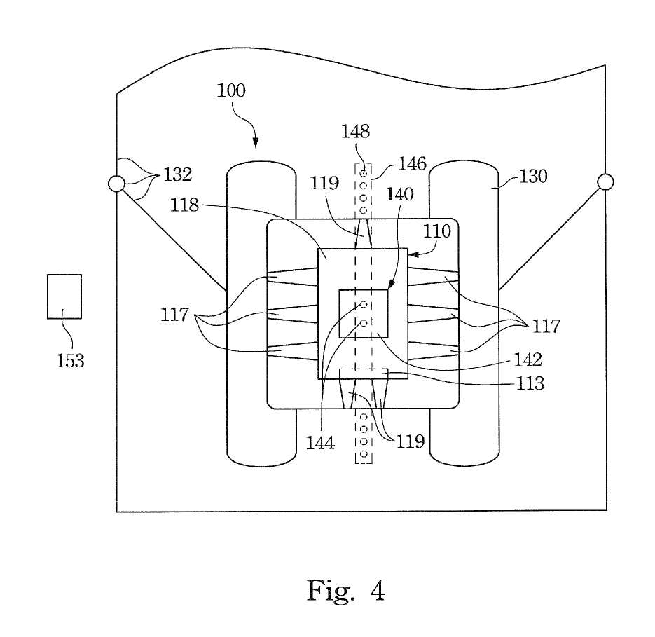

FIG. 4 is a top view of an aeration apparatus 100 of a third embodiment of the present invention. In this embodiment, the aeration apparatus 100 includes the cruising device 110, the aeration device 140, and the raft 130. The cruising device 110 includes a single pump 118 mounted on the raft 130, a filter (not shown) attached to the water inlet of the pump 118 underwater, a plurality of nozzles 117, 119 mounted on the water outlet of the pump 118, a valve 113, and a valve controller 153. The pump 118 pumps and discharges water through the nozzles 117, 119 to generate thrust to propel the raft 130.

A single nozzle 119 is located on the front side of the cruising device 110, and two nozzles 119 are located on the back side of the cruising device 110. Three nozzles 117 are disposed in a symmetrical arrangement on each of the left and the right sides of the cruising device 110.

Furthermore, the valve 113 (e.g., a motor valve or a solenoid valve) is connected to the two nozzles 119 located on the back side of the cruising device 110 for shutting on and off water flow. The valve controller 153 is electrically connected to the valve 113 for shutting on and off water flow to control the direction of the resultant thrust of water flow.

In this embodiment, each of the three nozzles 119 located on the front and back sides of the cruising device 110 discharges the same amount of water. The aeration apparatus 100 is propelled in a direction toward the front side of the cruising device 110 (i.e., the side with the single nozzle 119) generating smaller thrust When the valve controller 153 open the valve 113.

The two nozzles 119 located on the back side are closed when the valve controller 153 closes the valve 113. The aeration apparatus 100 is, therefore, propelled in a direction toward the back side (i.e., the side with the two nozzles 119) of the cruising device 110 since the resultant thrust is provide from single nozzle 119

In practice, different numbers of the nozzles 119 of the same diameter are located on front and back sides of the cruising device 110, respectively. In other embodiments, the nozzles 119 may be located such that while the number thereof is the same on the front and back sides of the cruising device 110, the diameters thereof are different on the front and back sides of the cruising device 110.

Moreover, each of the six nozzles 117 located on the left and the right sides of the cruising device 110 still discharges the same amount of water. The thrusts generated from the left and the right sides of the cruising device 110 are designed to achieve a balance with little effect on the propelling direction of the aeration apparatus 100 because the nozzles 117 are arranged symmetrically on the left and the right sides of the cruising device 110.

Accordingly, the aeration apparatus 100 can be propelled back and forth by using the above methods. It is to be noted that the elements shown in FIG. 4 may be the same as the elements shown in FIG. 1 or FIG. 3.

External guiding members 132 may be connected to the left and the right sides of the aeration apparatus 100. The members 132 are used to limit the aeration apparatus 100 in the designed direction with less deviation off the designed route due to wind, water currents, or other external forces. The guiding member 132 may be a rope or a separating line with floating rings used in a swimming pool.

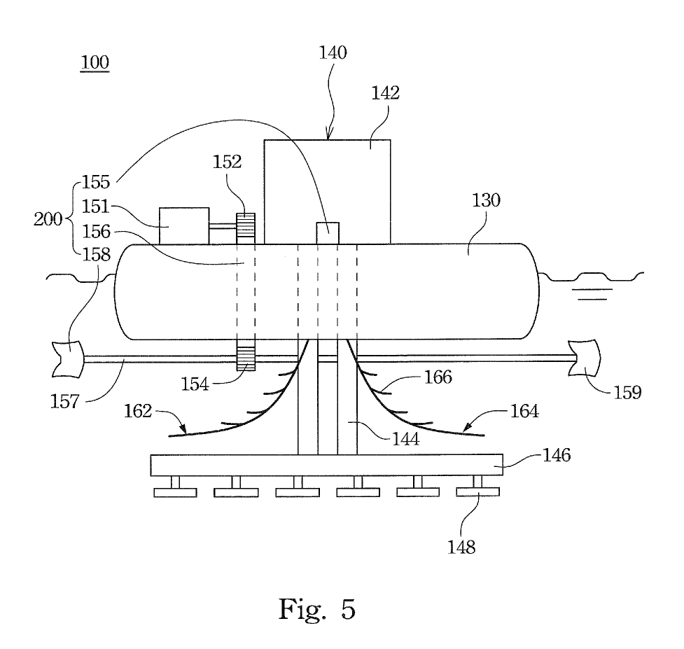

FIG. 5 is a side view of an aeration apparatus 100 of a fourth embodiment of the present invention. The aeration apparatus 100 includes a cruising device 200, the aeration device 140, and the raft 130. The cruising device 200 of the aeration apparatus 100 includes a motor 151, a transmission device 156 (e.g., a chain or a timing belt), a transmission shaft 157, a pair of impellers (i.e., a first impeller 158 and a second impeller 159), and a motor controller 155. The motor 151 is placed on the raft 130.

The transmission shaft 157 is located under the raft 130. The first impeller 158 and the second impeller 159 are implemented on the opposite ends of the transmission shaft 157.

The transmission device 156 is a chain or a timing belt, and is connected to a gear wheel 152 located on the output shaft of the motor 151 and another gear wheel 154 located on the transmission shaft 157.

It is to be noted that the clock-wise (CW) rotation of the transmission shaft 157 leads to CW rotation of the first impeller 158 and Counter clock-wise (CCW) rotation of the second impeller 159. Moreover, the CCW rotation of the transmission shaft 157 leads to CCW rotation of the first impeller 158 and CW rotation of the second impeller 159 vice versa.

The motor controller 155 is electrically connected to the motor 151 for controlling the motor 151 to rotate clockwise, counterclockwise, and the corresponding rotation directions of the output shaft of the motor 151, the transmission shaft 157, the first impeller 158 and the second impeller 159, respectively. The aeration apparatus 100 can be, therefore, propelled back and forth or stop by the motor controller 155 according to the CW rotation directions of the first impeller 158 or the second impeller 159.

Furthermore, the aeration apparatus 100 may further include at least one agitation device. In this embodiment, two agitation devices 162, 164 are located under the raft 130. At least a portion of each of the agitation devices 162, 164 is located under the water surface. Each of the agitation devices 162, 164 includes oblique boards 166 connected to the agitation device 162, 164 in a manner spaced apart along the length of the agitation device 162, 164. Moreover, the shape of agitation devices 162, 164 is changing gradually from horizontal to vertical. The agitation devices 162, 164 agitate an upper water layer and are propelled with the raft 130. The agitation devices 162 and 164 further increase the DO concentration of water due to the corresponding disturbance when the bubbles are discharged from the air diffusers 148 in the lower water layer rising toward the upper water layer.

As a result, the aeration apparatus can be propelled via operation of the motor, aerate through releases of air bubbles in the lower water layer adjacent to the bottom of the pond via operation and correct positioning of the aeration device, and agitates water flow through the presence of the agitation device.

It is to be noted that the elements shown in FIG. 5 may be the same as the elements shown in FIG. 1, FIG. 3, or FIG. 4.

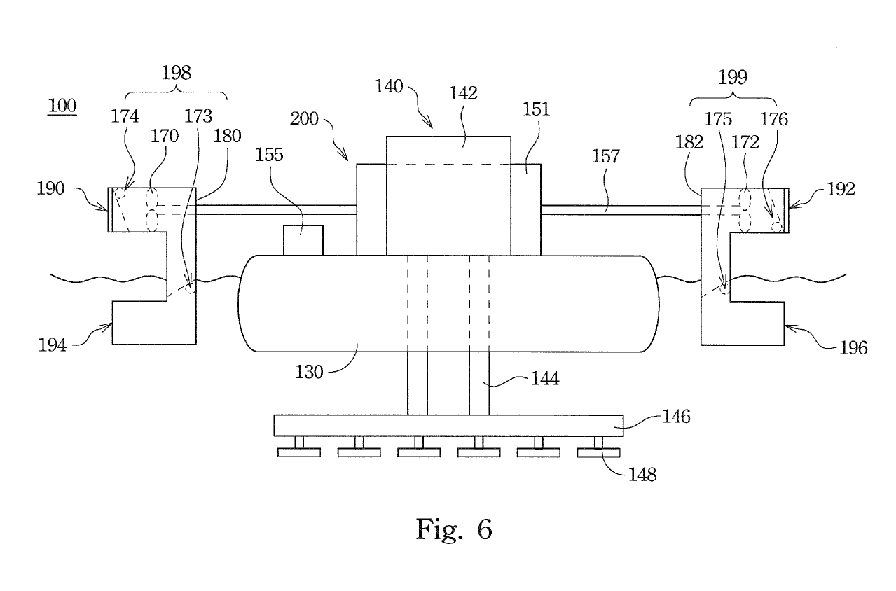

FIG. 6 is a side view of an aeration apparatus 100 of a fifth embodiment of the present invention. The aeration apparatus 100 includes a cruising device 200, the aeration device 140, and the raft 130. The cruising device 200 includes a motor 151, a transmission shaft 157, a pair of pumping devices for discharging water to generate thrust (i.e., a first pumping device 198 and a second pumping device 199), and a motor controller 155.

The motor 151 is placed on the raft 130, and the transmission shaft 157 connects the motor 151. The first pumping device 198 and the second pumping device 199 are assembled on two ends of the transmission shaft 157 and in opposite normal rotating directions according to a rotating direction of the motor 151.

The first pumping device 198 includes a first impeller 170 and a first fluid chamber 180 with a first water inlet 194 and a first nozzle 190. The first impeller 170 is located in the first fluid chamber 180

Similarly, the second pumping device 199 includes a second impeller 172 and a second fluid chamber 182 with a second water inlet 196 and a second nozzle 192. The second impeller 172 is located in the second fluid chamber 182. The first impeller 170 and the second impeller 172 are disposed on two ends of the transmission shaft 157, and arranged in opposite rotation directions.

The first nozzle 190 and the second nozzle 192 are arranged in opposite directions. The first water inlet 190 and the first nozzle 194 are located facing away from the second water inlet 192 and the second nozzle 196 in a symmetrical arrangement. Each of the first fluid chamber 180 and the second fluid chamber 182 extends along a generally sideways U-shaped path.

The motor controller 155 is electrically connected to the motor 151 for controlling the motor 151 to rotate clockwise, counterclockwise, and stop, and the corresponding rotation directions of the transmission shaft 157, and the first impeller 170 and the second impeller 172.

The first pumping device 198 further includes one-way check valves 173, 174, and the second pumping device 199 further includes one-way check valves 175, 176. The check valves 173, 174 are located in the first fluid chamber 180. The check valves 173 and 174 allow the water flow passing through the first water inlet 194 without back flow and store water within the first chamber 180. Similarly, the check valves 175, 176 are located in the second fluid chamber 182. The check valves 175, 176 allow the water flow passing through the second water inlet 196 without back flow and store water within the second chamber 182.

When the transmission shaft 157 rotates clockwise (CW), the first impeller 170 rotates in a normal direction, so that water enters the first water inlet 190 of the first fluid chamber 180, after which the first nozzle 194 of the first fluid chamber 180 discharges the water. Furthermore, the second impeller 172 rotates in a reverse direction, so that only a small amount of water passes through the second fluid chamber 182. Namely, the water output of the first fluid chamber 180 is much larger than the water output of the second fluid chamber 182, so that the aeration apparatus 100 is propelled in a direction toward the second fluid chamber 182 due to the thrust generated by the first impeller 170. In contrast, when the transmission shaft 157 rotates counterclockwise (CCW), the aeration apparatus 100 is propelled in a direction toward the first fluid chamber 180 due to the thrust generated by the second impeller 172.

It is to be noted that the elements shown in FIG. 6 may be the same as the elements shown in FIG. 1, FIG. 3, FIG. 4, or FIG. 5.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An aeration apparatus comprising:
a raft for floating on a water surface;
a cruising device for propelling the raft back and forth on the water surface; and
an aeration device installed on the raft for diffusing a plurality of bubbles under the water surface.

2. The aeration apparatus as claimed in claim 1, wherein the aeration device comprises:
a blower placed on the raft;
an air diffuser located under the raft; and
an air pipe connecting an air outlet of the blower and the air diffuser.

3. The aeration apparatus as claimed in claim 2, wherein the air pipe extends from the air outlet of the blower to a depth which is above the bottom of a pond by 10 cm to 40 cm.

4. The aeration apparatus as claimed in claim 1, wherein the cruising device comprises:
at least one pump mounted on the raft;
at least one nozzle mounted on the water outlet of the pump, wherein the pump is for pumping and discharging water through the nozzle to generate thrust to propel the raft;
at least one filter attached to the water inlet of the pump;
at least one valve connected to the nozzle for shutting on and off the water flow; and
a valve controller electrically connected to the valve for shutting on and off water flow to control a direction of thrust of water flow.

5. The aeration apparatus as claimed in claim 1, wherein the cruising device comprises:
at least a pair of pumping devices mounted on the raft for pumping and discharging water to generate thrust to propel the raft; and
a controller electrically connected to the pumping devices and alternately switching on and off one of the pumping devices to control the direction of thrust of water flow.

6. The aeration apparatus as claimed in claim 5, wherein each of the pumping devices comprises:
a pump;
a filter attached to the water inlet of the pump; and
a nozzle mounted on the water outlet of the pump, wherein the pump is for pumping and discharging water through the nozzle.

7. The aeration apparatus as claimed in claim 1, wherein the cruising device comprises:
a motor placed on the raft;
a transmission shaft located under the raft;
a pair of impellers implemented on opposite ends of the transmission shaft;
a transmission device connecting an output shaft of the motor and the transmission shaft; and
a motor controller electrically connected to the motor for controlling the motor to rotate clockwise, counterclockwise, and stop.

8. The aeration apparatus as claimed in claim 7, further comprising:
at least one agitation device disposed under the raft.

9. The aeration apparatus as claimed in claim 7, wherein the transmission device is a chain or a timing belt.

10. The aeration apparatus as claimed in claim 1, wherein the cruising device comprises:
a motor placed on the raft;
a transmission shaft connecting the motor;
a motor controller electrically connected to the motor for controlling the motor to rotate clockwise, counterclockwise, and stop; and
at least a pair of pumping devices assembled on two ends of the transmission shaft and in opposite normal rotating directions according to a rotating direction of the motor for discharging water to generate thrust.

11. The aeration apparatus as claimed in claim 10, wherein each of the pumping devices further comprises:
a fluid chamber with a water inlet and a nozzle;
an impeller; and
a plurality of check valves disposed in the fluid chamber, wherein the pair of impellers are respectively disposed on two ends of the transmission shaft and located in the fluid chambers, the nozzles are arranged in opposite directions, and the impellers are arranged in opposite directions.
